(19) United States
(12) Patent Application Publication
(10) Pub. No.: US 2005/0243723 A1
(43) Pub. Date: Nov. 3, 2005

(54) Multi-parameter load balancing device for a label switched communications network peripheral device

(75) Inventor: Claire-Sabine Randriamasy, Meudon (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/115,209

(22) Filed: Apr. 27, 2005

(30) Foreign Application Priority Data
Apr. 29, 2004 (FR) 04 50 821

(51) Int. Cl. H04L 12/26

(52) U.S. Cl. 370/235

(57) ABSTRACT

A device (D) is dedicated to load balancing in a label switched communications network comprising a set of label switched peripheral nodes (LER1 to LER5). The device (D) includes i) a first set of processing means charged with determining equivalent LSP paths between a source peripheral node (LER1) and each destination peripheral node (LER2-LER5) in the set, taking account of multiple parameters associated with the respective weights and with a designation of the critical links within the network, the equivalent switched paths being classified according to their associated cost values, and ii) a second set of processing means charged with selecting from amongst the equivalent LSP paths, determined by the first processing means, a set of LSP paths equivalent and alternate to an initial switched path, established between a source peripheral node (LER1) and a destination peripheral node (LER3) and including a critical link, and then determining a balance between the alternate and equivalent LSP paths in this set, according to their respective cost values, for traffic that must take the said initial switched path.

The invention concerns the field of label switched networks, and more specifically the load (or traffic) balancing devices used in such networks.

Like many communications networks, a “label switched network”, for example of the MPLS or GMPLS type, can be briefly summarized as multiple connected switched devices comprising nodes intended to route data packets, or more generally data streams, between the communication terminals or the servers coupled to them. In a label switched network the switched devices are known as label switched routers (or LSRs).

LSRs denote two types of router or switch coupled together: the peripheral routers (or LERs for “Label Edge Routers”), charged with establishing a Label Switched Path (or LSP) for each data stream they receive when the network manager requests it, and the core routers (or LCRs), solely charged with the switching of data streams and the transmission of the network information data.

The establishment of a label switched path consists of adding a label, associated with the path to be taken, to a data stream and reserving the resources necessary for the routing of the stream, from the source node (LER) to the destination node (LER), taking account of the Type of Service (or ToS) and/or the Quality of Service (or QoS) that is (are) associated with this stream. So that each source LER can establish a path, each stream must be associated with a source LER and a destination LER, with a Forwarding Equivalence Class (or FEC) and with a set of service data defining the Type of Service (or ToS) and/or the Quality of Service (or QoS).

The calculation of a LSP switched path is achieved by either determining the shortest path between the outgoing and destination nodes, or by listing a set of nodes that it must contain.

From the list of nodes produced from the calculation, a process called signalization establishes the switched path after validation of the steps with consideration of the QoS and/or ToS constraints required for the stream.

A LSP switched path may be seen as a sequence of links established between neighboring LSP couples, starting at a source LER and terminating at a destination LER. Such a path is generally calculated by means of LSP switched path calculation software, in order to support traffic selected according to certain parameters, such as the available bandwidth, the number of hops (or links), the transfer time and the administrative cost.

As experts know, a link shared between several LSP switched paths, used by different traffic, may experience an overload, known as congestion.

In order to absorb these link congestions, load (or traffic) balancing devices were proposed. They all have the objective of reducing the traffic on a congested link by distributing part of the traffic between alternate LSP switched paths with the same source LER and destination LER as the congested link, in order to ensure continuity of service.

A first load balancing device, known as a MPLS-OMP (for “MPLS Optimized Multi-Path”), is an adaptation of the OSPF-OMP device to MPLS networks, in which, on the one hand, the load information relates to all the LSP switched paths and not only the links, and on the other hand, the establishment of an initial LSP switched path is based on a transfer time and the alternate LSP switched paths are generated by a SPF type algorithm from all the non-congested links. If a single alternate LSP switched path is generated, no distribution of traffic (or “load balancing”) occurs. Furthermore, the generation of alternate LSP switched paths occurs by relaxing one optimization parameter, such as the length of the path. More precisely, all the LSP switched paths presenting a deviation of less than or equal to two from the single parameter are retained. Moreover, this MPLS-OMP device permits the forced use of a LSP switched path that was not selected by OSPF-OMP.

This MPLS-OMP device presents at least two disadvantages: path selection relies on a single parameter, which is not optimal, and, although it rejects the congested links, it does not select the alternate LSP switched paths by taking their respective loads into consideration.

A second load balancing device, known as MATE (for “Multi-Path Adaptative Traffic Engineering”), implements an adaptive and distributed load balancing algorithm, designed in an attempt to remedy the above-mentioned disadvantages of the first device. This device relies on the assumption that several LSP switched paths are already available between a given source and destination LER. The congested links are detected by means of an active measurement mechanism consisting of periodically transmitting probe packets, in both directions, between the source LER and the destination LER in order to obtain the transmission time and the loss rate. The traffic is distributed between the LSP switched paths by optimizing a scalar cost function with constraints representative of the total traffic entering via the source LER and exiting via the destination LER and the traffic flow rate by using a given LSP switched path. Since the cost function takes the transfer times and marginal loss rates into consideration, no synchronization or direct traffic measurement is necessary.

This MATE device presents at least three disadvantages: the use of probe packets to detect congestions in a dense MPLS network can prove to be resource intensive; the LSP switched paths are supposed to have been previously calculated according to a long-term parameter, which means that their performances are not necessarily the best possible when the device is activated and they may include links that have become congested in the meantime; no traffic stabilization mechanism (in terms of progressive shifting) is provided for.

Since none of the current devices are completely satisfactory, this invention is intended to improve the situation.

With this end in view, it proposes a load-balancing device for a label switched communications network comprising a set of label switched peripheral nodes (or LERs).

This device is characterized by the fact that it includes:
a first set of processing means charged with determining equivalent labeled data stream switched paths (or LSPs) between a source peripheral node and each destination peripheral node in the set, taking account of multiple parameters associated with respective weights and a designation of critical links within the network; the equivalent switched paths being classified according to associated cost values, and
a second set of processing means charged with selecting from amongst the equivalent switched paths determined by the primary processing devices, a set of switched paths equivalent and alternate to an initial switched path, established between a source peripheral node and a destination peripheral node and including a critical link, and then with determining a distribution between the equivalent and alternate switched paths in this set, according to their respective cost values, for traffic that must follow the said initial switched path.

The device according to the invention may include other additional aspects that may be taken separately and/or in combination, and in particular:
the parameters used by the first processing means may be the available bandwidth, the number of hops, the transfer time and/or the administrative cost,
its first processing means may be constructed such that they operate in preventive mode. In this case, they determine the equivalent switched paths when they receive instructions from the network including the parameters and their respective weights and the designation of critical links (possibly in the form of their administrative costs). A critical link may therefore be either a congested link or a link that the network manager wishes to avoid using,
its first processing means may be constructed such that they operate in reactive mode. In this case, they determine the equivalent switched paths when they receive information designating at least one congested critical link within the network. This information may, for example, come from the detection means of the device charged with detecting congested critical links. Furthermore, the first processing means are preferably constructed such that they determine the equivalent switched paths after having modified the weights associated with the parameters. To this end, the first processing means may, for example, increase the weight that is given to the bandwidth parameter, then adjust the weight of the other parameters according to this increase, so that the sum of the weights of the parameters used is equal to one and the proportions between weights are maintained,
its first processing means preferably determine the equivalent switched paths from the updated bandwidth values of the links and from the current network topology, in particular in preventive mode,
its second processing means can be constructed so as to, on the one hand, submit to a dynamic hashing function the data streams received by the source peripheral node and defined by network source, network destination, source port and destination port parameters, in order to deliver a chosen number of value bins and, on the other hand, allocate the value bins, representative of the data streams received, to the equivalent and alternate switched paths in the set according to their respective cost values. In this case, the second processing means may be charged with allocating the data streams received, during a selected time interval and according to an incremental stream shifting, to each of the equivalent and alternate switched paths in the set, the stream shifting on one of the paths being interrupted when the associated traffic balancing, based on cost value, is achieved.

The second processing means then preferably and progressively shifts the stream according to a selected pace shifting and/or a selected shifting speed,
its second processing means can be charged with updating the routing table of a source peripheral node after determining the equivalent and alternate switched paths in the set and the traffic distribution,
its first and second processing means are preferably interfaced to a TE (Traffic Engineering) extension link state routing protocol, and to “OSPF-TE” in particular.

The invention also concerns a network peripheral, such as a label switched router, defining a peripheral node for a label switched communications network and comprising a load balancing device of the aforementioned type.

Furthermore, the invention is particularly well suited to MPLS (“MultiProtocol Label Switched”) type label switched communications networks that process streams consisting of packets or cells of asynchronous data, or GMPLS (“Generalized MPLS”) type networks that process streams consisting not only of packets or cells of asynchronous data but also of synchronous frames or light streams.

Other aspects and advantages of the invention will appear from the examination of the detailed description below, and of the drawings appended, in which:

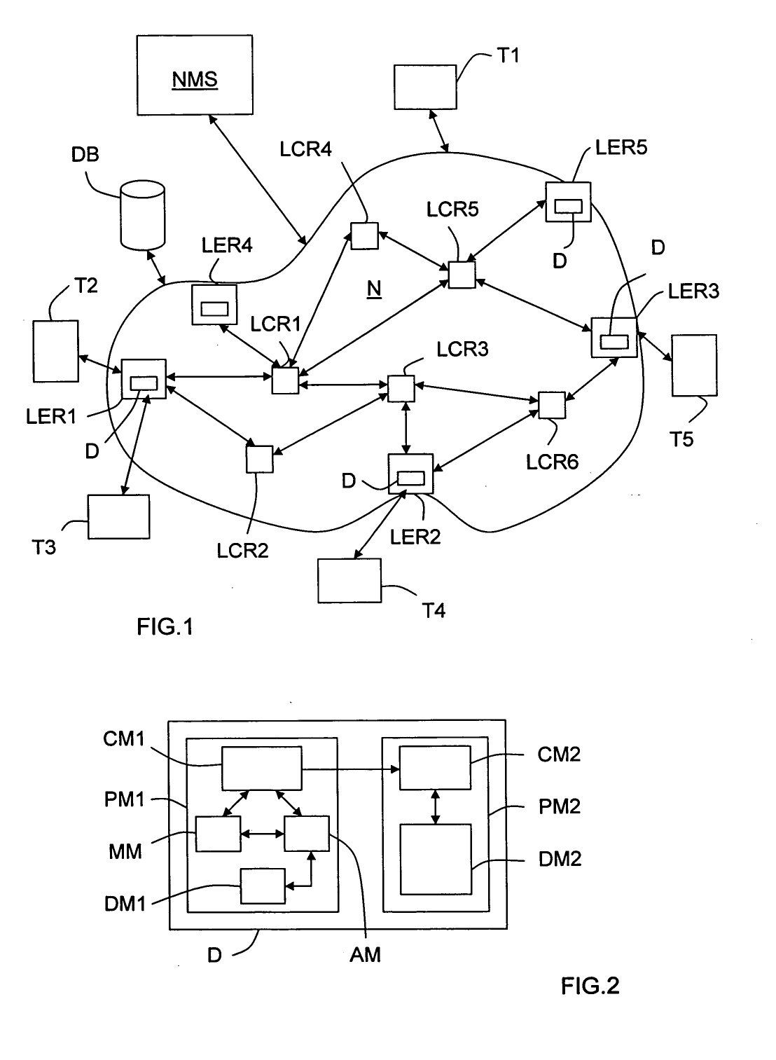

FIG. 1 diagrammatically illustrates an example of a label switched communications network comprising multiple peripheral routers (or nodes) (LERs), equipped with a load balancing device according to the invention, and coupled together by the core routers (or nodes) (LCRs),

FIG. 2 diagrammatically illustrates an embodiment of a load balancing device according to the invention, and

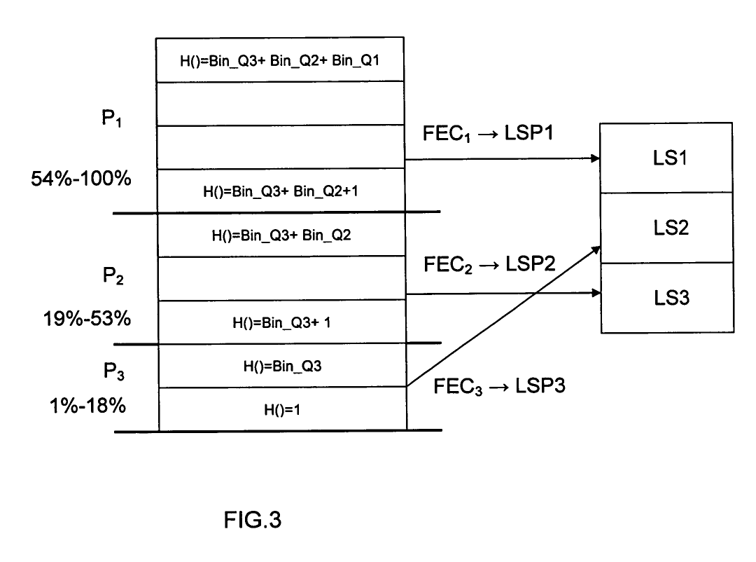

FIG. 3 diagrammatically illustrates an example of incremental traffic phase shifting by means of a hashing function, where traffic is distributed between three alternate LSP paths.

The drawings appended not only complement the invention, but also contribute to its definition, where appropriate.

Let us first refer to FIG. 1 in order to describe a non-restrictive example of a Label Switched Network incorporating network devices (LERn, LCRm) that define the nodes and are each equipped with a load-balancing device according to the invention.

In the following, we have assumed that the network is of the IP MPLS type (“Internet Protocol MultiProtocol Label Switched”). Of course, the invention is not restricted just to this type of label switched network. Generally speaking, it concerns all types of label switched networks, such as, for example, IP GMPLS (“IP Generalized MultiProtocol Label Switched”) type networks.

An IP MPLS network generally comprises multiple label switched routers (or nodes) (LSRs) coupled together. These LSRs can be grouped into two categories: Label Edge Routers (or LERs) LERn (here n=1 to 5), and Label Core Routers (or LCRs) LCRm (here m=1 to 6). As we will see further on the LER routers are charged with establishing the switched paths within the network while the LCR routers are charged with the actual switching.

Furthermore, in the following, “link” means a connection between two LSR routers, and “LSP path (or route)” means a path between a source LER peripheral router and a destination LER peripheral router, defined by a sequence of links. In addition, a node (or router) that follows another node within a LSP path is generally referred to as the “next hop”. The number of hops in a LSP path therefore defines its length.

A LSP path is generally calculated so as to optimize the transmission of traffic between a source LER peripheral router and a destination LER peripheral router. In an IP MPLS network, each LER peripheral router is constructed, if it constitutes a source (LERs), such that it calculates the best LSP path for transferring the data streams that it receives towards the destination LER peripheral router (LER_{D}), taking account of the service associated with the streams, the current network topology and the current link loads.

The IP MPLS network generally includes a database DB, which in particular stores the current network topology and the current link loads. The LER peripheral routers are therefore coupled to this database DB, which is preferably of the TE-LSA (for “Traffic Engineering—Link State Advertisement”) type, and communicate with it according to a TE (Traffic Engineering) link state routing protocol such as “OSPF-TE”.

The IP MPLS network also includes a Network management System, or NMS, charged with transmitting data to the LSR routers and extracting data from them in order to permit management of the network by an administrator (or manager).

It is important to note that the destination LER peripheral router of a LSP path is the final router to which a labeled packet is transmitted within a zone (or domain), but not the destination address of the said labeled packet.

Multiple user or company terminals Ti (here i=1 to 5) are likely to connect to certain LERs so that data can be exchanged between them.

In the following we have assumed that the terminals Ti are mobile devices, such as mobile telephones (or cellular phones). However, the following applies to all types of communication terminals capable of exchanging data with other terminals or network devices, such as, for example, fixed line telephones, fax machines, PDAs, desktop computers or laptops or Application Service Providers (or ASP).

The invention is intended to permit load (or traffic) balancing within a label switched communications network (here an IP MPLS).

To this end, the invention proposes embedding a load (or traffic) balancing device D preferably in each of the network's peripheral routers LERn.

This device D is not only charged with calculating the best LSR paths along which to transmit the data streams received to a destination LER router, but also with resolving (or absorbing) link congestions by means of a load balancing mechanism.

Link congestion can occur for the following reasons:
a technical problem on a link that may cause overloading of the neighboring link(s) and alterations to the network topology,
a link overload caused by the incorrect assessing of its load rather than by a technical problem, and
an increase in regional traffic, without technical problems, which does not alter the network topology.

Within the context of lP MPLSs according to the invention, load balancing is activated in reactive mode in each source LER peripheral router that receives traffic and that is momentarily connected to a destination LER peripheral router via at least one critical link. However, as a variant or complement, it may also be activated in preventive mode in order to comply with the network administrator's instructions.

The device D according to the invention, illustrated in FIG. 2, firstly comprises a first processing module PM1 charged with determining the equivalent labeled data stream switched paths (or LSP paths) between a source LER peripheral router and each destination LER peripheral router within the network (or domain) considered, taking account of multiple parameters associated with respective weights and with a designation of critical links within the network. Each equivalent LSP path is provided with an associated cost value to allow the defining of its classification in comparison with the other equivalent LSP paths provided.

This first processing module PM1 is preferably of the type referred to by the English acronym MCLC (“Multi-Criteria LSP Calculation”), which is specifically described in the patent document bearing the file number FR 02 15966, the contents of which are included here as a reference.

In the following description, we have assumed that the first processing module PM1 is a MCLC module. Since this is described in the above-mentioned patent document, it shall not be described in detail hereinafter.

Remember that a MCLC module simultaneously uses several parameters associated with relative weights (defining a cost vector) in order to determine the link values and provide LSP paths that offer equivalent performances (that is, pareto-optimal) for each destination LER peripheral router within the network (or domain) considered. The LSP paths provided, known as “equivalent LSP paths”, can thus be classified according to a cost value that is based on the priority (or the relative weight) of each parameter is selected and the deviation from the highest value observed.

The parameters used by such a MCLC module are preferably selected from a group comprising at least the available bandwidth, the number of hops, the transfer time and the administrative cost. The selecting of the initial parameters and their respective relative weights depends on the network administrator.

Furthermore, such a MCLC module is preferably interfaced to an OSPF-TE link state routing protocol.

Each device D according to the invention also comprises a second processing module PM2 coupled to the first processing module PM1 and charged with dynamic load balancing in reactive mode and/or preventive mode. In the following we have assumed that the device D operates in both reactive and preventive mode.

As with the first processing module PM1, the second processing module PM2 is preferably interfaced to an OSPF-TE link state router protocol.

When a source router LERn receives a data stream to be transmitted to a destination router LERn', via an initial LSP path, including at least one critical link (possibly congested), the second processing module PM2 of the device D begins by first selecting a set of K LSP paths equivalent and alternate to the initial LSP path, from amongst the equivalent LSP paths that are provided by the first processing module PM1. The K LSP paths in a set are referred to hereinafter as Pₖ, where k=1 to K.

Remember that the first processing module PM1 provides equivalent LSP paths beginning at its source LER router and ending at one of the destination LER routers within the network (or domain) concerned.

The second processing module PM2 then determines an unequal distribution of the traffic needing to take the initial LSP path between the equivalent and alternate LSP paths Pₖ in the set according to their respective cost values Mₖ.

As indicated above, the device D can be activated either in reactive or preventive mode.

In preventive mode the IP MPLS network administrator sends instructions to the source LER router concerned, via the NMS and the network, comprising the relevant parameters and relative weights that must be used by the first module PM1, and the designation (or identity) of one or more critical links, which may be represented as an administrative cost. Of course, other parameters, specifying, for example, the date and/or the time and/or the duration during which the device D must implement dynamic load balancing may also be transmitted to the source LER router concerned. This preventive mode will be described below.

In reactive mode, the device D is activated when it receives the designations (or identities) of one or more critical links whose congestion was detected by a detection module DM1 during a verification (TE-LSA) of the contents of the database DB. Such a detection module DM1 may be either an external module connected to the source LER router, or a module internal to device D, which is integrated, for example, into the first processing module PM1 as illustrated in FIG. 2.

It is important to note that in the absence of congestion, the optimum LSP path may be calculated either by the first processing module PM1 (MCLC module) as part of its standard operating, or by another LSP path calculation module. This other calculation module may be for example a Dijkstra type module. However, if the second processing module PM2 needs to be called on, the first processing module PM1 must be used.

If the detection module DM1 detects congestion during a verification phase (TE-LSA), it activates the first processing module PM1 and the second processing module PM2. More specifically, the first processing module PM1 comprises a management module MM coupled with the detection module DM1 and charged with interrupting the interval timers controlling the calculation of regular LSP paths, in order to replace them with link load, time elapsed and load variation counters. Counters of this type are, for example, described in the document by C. Villamizar: “OSPF Optimized multipath (OSPF-OMP)”, IETF draft, draft-ieff_ospf-omp-03, January 2002.

The first processing module PM1 comprises an adaptation module AM coupled with the management module MM and is charged with determining a new weight for at least one of the parameters used in the absence of congestion. Given that the main cause of the congesting of a link is an overload, it is the weight W_{BW} of the available bandwidth parameter that is preferably modified, and more specifically increased (providing that the network administrator does not reject this option). The other (regular) parameters are preserved (these are usually the theoretical transfer time, the length of the path, the load and/or the administrative cost).

After increasing the relative weight W_{BW} of the available bandwidth parameter using a predetermined formula, the adaptation module AM adjusts the respective weights W_{q} (q≠WB) of the other (regular) parameters so that the total sum of all the relative weights is equal to 1 and the predefined proportions between the weights W_{q} are maintained.

We can use the following formula, for example, to update the relative weight W_{BW} of the available bandwidth parameter: W_{BW}⁺=(1−W_{BW})/R_{B}, where W_{BW}⁺is the updated weight and R_{B} is a value greater than 1, and preferably greater than or equal to 2 by default, and representative of the bandwidth parameter relative weight incremental ratio.

A calculation module CM1, of the first processing module PM1, calculates all the equivalent LSP paths Pₖ that can be respectively established between its source LER router (LERₛ) and each of the destination routers LER_{D} within the network (or domain) concerned, and the associated cost values Mₖ, as described in the above-mentioned patent document. It does this by using the parameters and their new relative weights supplied by the adaptation module AM, as well as the information from the database DB (in particular that concerning the current network topology, the current link loads and the congested links). The equivalent LSP paths Pₖ can thus be classified according to their associated cost values Mₖ. The best LSP path, for example, is referred to as P₁ and is associated with the best cost value M₁ (M₁≧M₂ . . . ≧Mₖ, where M_{K} is the worst of the values).

The second processing module PM2 comprises a calculation module CM2 charged with receiving the definitions of the K equivalent LSP paths pₖ, and the associated cost values Mₖ, provided by the first processing module PM1, in order to determine the dynamic load balancing.

This dynamic load balancing begins firstly with the preselecting from amongst the K equivalent LSP paths pₖ of the equivalent LSP paths that share the destination LER router (LER_{D}) to which the stream received must be transmitted. This preselection provides K′ LSP paths equivalent and alternate to the LSP path initially planned, including at least one congested link.

For example, the initial LSP path passes through the source router LER1, the router LCR1, the router LCR5 and the destination router LER3, and the link between the routers LCR1 and LCR5 is congested.

Dynamic load balancing is then implemented by selecting, from amongst the K′ preselected LSP paths, a set of L equivalent LSP paths Pₗ alternate to the initial congested LSP path.

This selection is made according to the classification (and therefore the cost values Mₗ) of the preselected paths. For example, the calculation module CM2 decides to select the three (l=1 to 3) best paths P₁ to P₃, whose cost values are M₁=80, M₂=60 and M₃=30 respectively.

For example, the LSP path P₁ passes through the source router LER1, the router LCR1, the router LCR4, the router LCR5 and the destination router LER3, the LSP path P₂ passes through the source router LER1, the router LCR1, the router LCR3, the router LCR6 and the destination router LER3, and the LSP path P₃ passes through the source router LER1, the router LCR2, the router LCR3, the router LCR5 and the destination router LER3.

The calculation module CM2 then determines the proportion Qₗ of traffic that may be allocated to each LSP path Pₗ selected, taking account of its cost value Mₗ. Qₗ is defined by the following relation:

$${Q}_{l} = \frac{{M}_{l}}{{\sum }_{l} {M}_{l}}$$

In the above-mentioned example, in which three LSP paths are selected, the LSP path P₁ is allocated Q₁=47% of the traffic, the LSP path P₂ is allocated Q₂=35% of the traffic, and the LSP path P₃ is allocated Q₃=18% of the traffic.

The calculation module CM2 then deducts from the allocated proportions of traffic Qₗ the multi-cost coefficients Cₗ that characterize, for the selected path Pₗ, the factor by which the number of single value bins allocated to the worst selected path P_{L} (here P_{L}=P₃) must be multiplied in order to find out the number of bins reserved for it (here P₁ or P₂). Cₗ is given by the following formula:

$${C}_{l} = \frac{{Q}_{l}}{{Q}_{L}}$$

In the above-mentioned example, in which three LSP paths are selected, if C₃ is equal to 1 for the worst LSP path P₃, then C₁ is equal to 2.66 for the LSP path P₁ and C₂ is equal to 2 for the LSP path P₂.

The calculation module CM2 provides a distribution module DM2 that comprises the second processing module PM2 with traffic allocation proportions Qₗ and multicost coefficients Cₗ.

The distribution module DM2, located in the source LER router, is charged with distributing the packets of traffic flow data received that need to be transferred to the destination LER router concerned.

To this end, it defines what is known by experts as Forwarding Equivalence Classes equal in number to the number L of LSP paths Pₗ selected.

Remember that in a label switched network a stream is identified by a FEC that directs all this stream's data to the same single LSP path. The association of a stream to be switched with a FEC is carried out by the source LER router.

Thus, the FECₗ corresponds to the LSP path Pₗ selected, which must transport Ql % of the stream received, to be transferred.

It may be noted that if a given FEC is allocated to a given flow, then it corresponds to a single given LSP. However, several different FECs may be directed towards the same LSP. Consequently, to permit the load balancing to distribute the flows of an initial LSP to several other LSPs (LSP1 to LSPn), it is advisable to create the same number of FECs (FEC₁ to FECₙ).

The distribution module DM2 then preferably implements dynamic hashing in order to distribute (or balance), in an unequal manner, the data streams received by its source LER router, as illustrated in FIG. 3.

The distribution of traffic in an MPLS network is naturally flow-based. Furthermore, interruptions of flow can be minimized by means of a hashing schema for dynamic flow identifiers.

The data flows are represented by bytes comprising the protocol identifier, the source and destination MPLS ports, and the source and destination lP addresses, as well as other properties, for example related to the quality of service (QoS).

A hashing function H( ) is applied to the different flow identifiers in order to provide a selected number of value bins Bin_q, for example q=1 to 100, so that each bin corresponds to 1% of the flows to be balanced. The distribution module DM2 then allocates these value bins (Bin_q), representative of the data flows received, to the L LSP paths Pₗ selected, according to the associated traffic proportions Qₗ previously determined.

For example, and as illustrated in FIG. 3, the allocation of data flows can occur as follows.

For example, FEC₃ is allocated to flows F such that H(F) belongs to the interval [0, Bin_Q₃=18%] that corresponds to Bin_{—}1 to Bin_{—}18, FEC₂ is allocated to flows F such that H(F) belongs to the interval [Bin_{—Q}₃, Bin_Q₃+Bin_Q₂=53%] that corresponds to Bin_{—}19 to Bin_{—}53, and FEC₁ is allocated to flows F such that H(F) belongs to the interval [Bin_Q₃+Bin_Q₂, Bin_Q₃+Bin_Q₂+Bin_Q ₁=100%] that corresponds to Bin_{—}54 to Bin_{—}100.

In FIG. 3, the acronyms LS1 to LS3 denote the three outgoing links used. This is only an example for illustrative purposes; the number of outgoing links may be in fact be less than or equal to the number of FECⱼ.

This allocation represents the objective that the distribution module DM2 must achieve in a given period of time by means of an incremental data stream shifting of the initial LSP path (including the critical link) to the various selected LSP paths Pₗ. The distribution module DM2 preferably interrupts the data flow shifting to a selected LSP path Pₗ when the target proportion of allocated traffic Qₗ is reached.

In order to avoid variations in traffic, the distribution module DM2 progressively shifts the traffic from one selected LSP path to the other according to a selected pace shifting and/or selected shifting speed. For example, the pace shifting may be fine tuned by means of mechanisms such as those used in the OSPF-OMP algorithm (defining, for example, the basic quantity of flow to be shifted at the same time and the number of quantities and rules used to decide when the pace shifting must be adjusted).

Furthermore, the distribution module DM2 can be constructed so as to implement a stabilization (or hysteresis thresholding) mechanism intended to distribute the flow allocated to a selected LSP path when its load exceeds a selected threshold (for example equal to 50%) and interrupt this distribution when its load is less than or equal to the said threshold reduced by another selected threshold (for example equal to 30%).

Furthermore, after balancing the load (or traffic), the second processing module PM2 preferably updates the database DB and the routing table stored in a dedicated memory in its source LER router.

The operation of a device D in preventive mode is similar to operation in reactive mode, described above.

A first difference arises from the mode of activation of the management module MM of the first processing module PM1. The module is in fact activated when it receives instructions from the IP MPLS network administrator, as previously indicated.

Once activated, the management module MM interrupts the interval timers controlling the calculation of the regular LSP paths, as in reactive mode.

The adaptation module AM then increases (or alters) the weight of at least one of the parameters used in the absence of congestion (for example the weight w_{BW} of the available bandwidth parameter), in accordance with the instructions received from the network administrator. The adaptation module AM then adjusts the respective weights W_{q} (q≠WB) of the other (regular) parameters, as in reactive mode.

Preferably, the adaptation module AM queries the database DB in order to obtain information relating to the current network topology and the current link loads. It then supplies this information to the calculation module CM1 as well as the parameters and associated relative weights to be used.

The calculation carried out by the calculation module CM1 is identical to that described above with reference to reactive mode. Moreover, the load balancing implemented by the second processing module is almost identical to that described above for reactive mode. The difference may in fact arise from the fact that the calculation module CM2 may be restricted to calculating the pace shifting and/or shifting speed according to the instructions received from the IP MPLS network administrator.

The load balancing devices D, and in particular their first processing module PM1 and second processing module PM2, may take the form of electronic circuits, software (or computer) modules, or a combination of circuits and software.

The invention offers load balancing devices distributed in each LER peripheral router, to allow the rapid, dynamic processing of congestion. Moreover, the invention is suited to both long congestions (lasting around an hour) and short congestions (lasting around one minute).

Furthermore, since the alternate LSP paths are calculated when the device is activated, they are determined according to updated network information, which ensures that LSP paths with congested links are excluded.

In addition, the invention increases robustness and stability as the traffic distribution remains unchanged along the entire length of each alternate LSP path.

The invention is not restricted to the embodiments of load balancing devices and label switched peripheral routers described above, by way of an example, but covers all variants that may be envisaged by experts within the framework of the claims set out below.

1. Load balancing device (D) for a label switched communications network comprising a set of label switched peripheral nodes (LER), characterized by the fact that it includes i) a first set of processing means (PM1) constructed so as to determine equivalent labeled data stream switched paths between a source peripheral node (LERS) and each destination peripheral node (LERD) of the said set, taking account of multiple parameters associated with the respective weights and with a designation of each critical link within the said network, the said switched paths being classified according to the associated cost values, and ii) a second set of processing means (PM2) constructed so as to select from amongst the said switched paths determined by the first processing means (PM1), a set of switched paths equivalent and alternate to an initial switched path established between a source peripheral node (LERS) and a destination peripheral node (LERD) and including a critical link, and then determine a balance between the switched paths equivalent or alternate to the said set, according to their respective cost values, for traffic that must take the said initial switched path.

2. Device according to claim 1, characterized in that the said parameter is selected from a group comprising at least the available bandwidth, the number of hops, the transfer time and the administrative cost.

3. Device according to claim 1, characterized in that the said first processing means (PM1) are constructed so as to determine the said switched paths upon receipt of instructions from the network comprising the said parameters, the said associated weights and the said critical link designations.

4. Device according to claim 1, characterized in that the first processing means (PM1) are constructed so as to determine the said switched paths if information is received designating at least one critical link within the said network.

5. Device according to claim 4, characterized in that it includes detection means (DM1) constructed so as to detect congested critical links and supply to the said first processing means (PM1) information designating at least one of the congested critical links detected.

6. Device according to claim 4, characterized in that the said first processing means (PM1) are constructed so as to determine the said switched paths after altering the weights associated with the said parameters.

7. Device according to claim 2, characterized in that the said first processing means (PM1) are constructed so as to determine the said switched paths after altering the weights associated with the said parameters, and further characterized in that the said first processing means (PM1) are constructed so as to increase the weight associated with the bandwidth parameter, then adjust the weights of the other parameters according to the said increase, so that the sum of the weights of the parameters used is equal to 1 and the proportions between the said weights are maintained.

8. Device according to claim 3, characterized in that the said first processing means (PM1) are constructed so as to determine the said switched paths from the updated link bandwidth values and the current network topology.

9. Device according to claim 5, characterized in that the said first processing means (PM1) are constructed so as to determine the said switched paths from the updated link bandwidth values and the current network topology.

10. Device according to claim 7, characterized in that the said first processing means (PM1) are constructed so as to determine the said switched paths from the updated link bandwidth values and the current network topology.

11. Device according to claim 1, characterized in that the said second processing means (PM2) are constructed i) so as to submit the data streams received by the source peripheral node and defined by the network source, network destination source port and destination port parameters, to dynamic hashing, in order to provide a selected number of value bins, ii) so as to then allocate the said value bins, representative of the said data streams received, to the said equivalent switched paths in the said set according to their respective cost values.

12. Device according to claim 5, characterized in that the said second processing means (PM2) are constructed i) so as to submit the data streams received by the source peripheral node and defined by the network source, network destination, source port and destination port parameters, to dynamic hashing, in order to provide a selected number of value bins, ii) so as to then allocate the said value bins, representative of the said data streams received, to the said equivalent switched paths in the said set according to their respective cost values.

13. Device according to claim 7, characterized in that the said second processing means (PM2) are constructed i) so as to submit the data streams received by the source peripheral node and defined by the network source, network destination, source port and destination port parameters, to dynamic hashing, in order to provide a selected number of value bins, ii) so as to then allocate the said value bins, representative of the said data streams received, to the said equivalent switched paths in the said set according to their respective cost values.

14. Device according to claim 11, characterized in that the said second processing means (PM2) are constructed so as to allocate the said data streams received, during a selected time interval and according to an incremental stream shifting, to each of the switched paths equivalent and alternate to the said set, said stream shifting on one of the said paths being interrupted when the associated traffic balancing, based on cost value, is achieved.

15. Device according to claim 14, characterized in that the said second processing means (PM2) are constructed so as to implement the said flow shifting in a progressive manner according to a selected pace shifting and/or shifting speed.

16. Device according to claim 1, characterized in that the second processing means (PM2) are constructed so as to update the source peripheral node (LERS) routing table after determining the switched paths equivalent or alternate to the said set and the said traffic balancing.

17. Device according to claim 1, characterized in that the said first (PM1) and second (PM2) processing means are interfaced to a “TE” extension link state routing protocol, and to “OSPF-TE” in particular.

18. Device according to claim 5, characterized in that the said first (PM1) and second (PM2) processing means are interfaced to a “TE” extension link state routing protocol, and to “OSPF-TE” in particular.

19. Device according to claim 7, characterized in that the said first (PM1) and second (PM2) processing means are interfaced to a “TE” extension link state routing protocol, and to “OSPF-TE” in particular.

20. Network peripheral device (LER), defining a peripheral node for a label switched communications network (N), characterized in that it includes a load balancing device (D) according to claim 1.

21. Network peripheral device (LER), defining a peripheral node for a label switched communications network (N), characterized in that it includes a load balancing device (D) according to claim 5.

22. Network peripheral device (LER), defining a peripheral node for a label switched communications network (N), characterized in that it includes a load balancing device (D) according to claim 7.

23. Peripheral device according to claim 20, characterized in that it comprises a label switched peripheral router.
